(19) United States
(12) Patent Application Publication
(10) Pub. No.: US 2006/0209961 A1
(43) Pub. Date: Sep. 21, 2006

(54) Video encoding/decoding method and apparatus using motion prediction between temporal levels

(75) Inventors: Woo-jin Han, Suwon-si (KR); Sang-chang Cha, Hwaseong-si (KR); Kyo-hyuk Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/378,357

(22) Filed: Mar. 20, 2006

Related U.S. Application Data
(60) Provisional application No. 60/662,810, filed on Mar. 18, 2005.

(30) Foreign Application Priority Data
May 3, 2005 (KR) 10-2005-0037238

(51) Int. Cl. H04N 11/02; H04N 11/04; H04B 1/66; H04N 7/12

(52) U.S. Cl. 375/240.16; 375/240.03; 375/240.18

(57) ABSTRACT

A video encoding/decoding method and apparatus is disclosed that can efficiently compress/decompress motion vectors in a video codec including a hierarchical temporal level decomposition process. The video encoding method including a hierarchical temporal level decomposition process involves obtaining a predicted motion vector of a second frame, which exists at a present temporal level, from a first motion vector of a first frame that exists at a lower temporal level; obtaining a second motion vector of the second frame by performing a motion estimation in a predetermined motion search area using the predicted motion vector as a start point; and encoding the second frame using the obtained second motion vector.

### CROSS-REFERENCE TO RELATED APPLICATIONS

This application claims priority from Korean Patent Application No. 10-2005-0037238 filed on May 3, 2005 in the Korean Intellectual Property Office, and U.S. Provisional Patent Application No. 60/662,810 filed on Mar. 18, 2005 in the United States Patent and Trademark Office, the disclosures of which are incorporated herein by reference in their entirety.

### BACKGROUND OF THE INVENTION

1. Field of the Invention

The present invention relates to the video encoding, and more particularly, to a video encoding/decoding method and an apparatus that can efficiently compress/decompress motion vectors using a hierarchical temporal level decomposition process.

2. Description of the Related Art

With the development of information and communication technologies including the Internet, multimedia communications are increasing in addition to text and voice communications. The existing text-centered communication systems are insufficient to satisfy consumers' diverse desires, and thus, multimedia services that can accommodate diverse forms of information such as text, image, music, and others, are increasing. Since multimedia data can be massive, mass storage media and wide bandwidths are required for storing and transmitting the multimedia data. For example, a 24 bit true color image having a 640*480 resolution requires a data capacity of 640*480*24 bits, i.e., 7.37 Mbits per frame. In the case of transmitting data at 30 frames per second, a bandwidth of about 221 Mbits/sec is required, and in the case of storing a movie having a running time of 90 minutes, a storage space of about 1200 Gbits is required. Accordingly, compression coding techniques are required to transmit the multimedia data.

The basic principle of data compression is to remove data redundancy. Data can be compressed by removing spatial redundancy such as the repetition of the same color or object in images, temporal redundancy such as little change of adjacent frames in moving image frames or the continuous repetition of sounds, and a visual/perceptual redundancy, which considers human beings' visual and perceptive insensitivity to high frequencies. Data compression can be divided into a lossy/lossless compression, intraframe/interframe compression, and symmetric/asymmetric compression, depending on whether source data is lost, whether compression is independently performed for respective frames, and whether the same time is required for compression and decompression, respectively. In addition, if the compression/decompression delay time does not exceed 50 ms, the corresponding compression is classified into a real-time compression, and if frames have diverse resolutions, the corresponding compression is classified as scalable compression. In the case of text data or medical data, lossless compression is used, and in the case of multimedia data, lossy compression is mainly used. In order to remove the spatial redundancy, intraframe compression is used, and in order to remove temporal redundancy, interframe compression is used.

In order to transmit multimedia generated after the data redundancy is removed, transmission media are required, the performances of which differ. Presently used transmission media have diverse transmission speeds. For example, an ultrahigh-speed communication network can transmit several tens of megabits of data per second and a mobile communication network has a transmission speed of 384 kilobits per second. Related art video coding methods, such as MPEG-1, MPEG-2, H.263 and H.264, remove temporal redundancy by motion compensation, and remove spatial redundancy by transform coding on the basis of a motion compensated prediction method. These methods have a good compression rate, but they are not flexible enough for a true scalable bitstream since their main algorithm uses a recursive approach. Recently, research has been directed towards wavelet-based scalable video coding. Scalable video coding means video coding having scalability. The scalability includes spatial scalability, which refers to adjusting the resolution of a video, signal-to-noise ratio (SNR) scalability, which refers to adjusting the picture quality of a video, temporal scalability which refers to adjusting the frame rate, and a combination thereof.

Also recently, temporal scalability, which is capable of generating a bitstream having diverse frame rates from a pre-compressed bitstream, is in demand.

At present, the Joint Video Team (JVT), which is a joint group of the Moving Picture Experts Group (MPEG) and the International Telecommunications Union (ITU), has been expediting the standardization of the H.264 Scalable Extension (hereinafter referred to as “H.264 SE”). H.264 adopts a technology called motion compensated temporal filtering (MCTF) in order to implement temporal scalability. Specifically, 5/3 MCTF, which refers to both adjacent frames when predicting a frame, has been adopted as the present standard. In this case, respective frames in a group of pictures (GOP) are hierarchically arranged so that they can support diverse frame rates.

FIG. 1 is a view illustrating an encoding process according to 5/3 MCTF. In FIG. 1, frames marked with slanted lines denote original frames, unshaded frames denote low frequency frames (L frames), and shaded frames denote high frequency frames (H frames). A video sequence passes through several temporal level decomposition processes, and temporal scalability can be implemented by selecting part of the temporal levels.

At the respective temporal levels, the video sequence is decomposed into low frequency frames and high frequency frames. First, the high frequency frame is produced by performing temporal prediction using two adjacent input frames. In this case, both forward temporal prediction and a backward temporal prediction can be used. Also, in the respective temporal levels, the low frequency frame is updated by using the two closest high-frequency frames among the produced high frequency frames.

This temporal level decomposition process can be repeated until only two frames remain in the GOP. Since the last two frames have only one reference frame, temporal prediction and updating of the frames may be performed by using only one frame in one direction, or the frames may be encoded by using the I-picture and P-picture syntax of H.264.

An encoder transmits to a decoder one low frequency frame 18 of the uppermost temporal level T(2) and high frequency frames 11 to 17, all of which were produced through the temporal level decomposition process. The decoder inversely performs the temporal prediction process of the temporal level decomposition process to restore the original frames.

Existing video codecs such as MPEG-4 and H.264 perform temporal prediction so as to remove the similarity between the adjacent frames on the basis of motion compensation. In this process, optimum motion vectors are searched for in the unit of a macroblock or a sub-block, and the texture data of the respective frames are coded by using the optimum motion vectors. Data to be transmitted from the encoder to the decoder includes the texture data and motion data such as the optimum motion vectors. Accordingly, it is important to compress the motion vectors more efficiently.

Accordingly, since the coding efficiency is lowered if the motion vector is coded as it is, the existing video codec predicts the present motion vector by utilizing the similarity in the adjacent motion vectors, and encodes only the difference between the predicted value and the present value to heighten the efficiency.

FIG. 2 is a view explaining a related art method of predicting a motion vector of the present block M by using motion vectors of neighboring blocks A, B, and C. According to this method, a median operation is performed with respect to the motion vectors of the present block M and the three adjacent blocks A, B, and C (the median operation is performed with respect to horizontal and vertical components of the motion vectors), and the result of the median operation is used as the predicted value of the motion vector M of the present block. Then, the difference between the predicted value and the motion vector of the present block M is obtained and encoded to reduce the number of bits required for the motion vector.

In the video codec that does not require considering of the temporal scalability, it is sufficient to predict the motion vector of the present block (i.e., spatial motion prediction) by using the motion vectors of the neighboring blocks (hereinafter referred to as “neighboring motion vectors”). However, in the video codec that performs the hierarchical decomposition process, such as MCTF, there is a spatial relation and a temporal relation between the temporal levels of the motion vectors. In the following description, predicting an actual motion vector is defined as “motion prediction”.

In FIG. 1, solid-line arrows indicate temporal prediction steps that correspond to a process of obtaining a residual signal (H frame) by performing motion compensation on the estimated motion vectors. As shown in FIG. 1, since the frames are decomposed by temporal levels, it can be recognized that the arrangement of solid-line arrows has a hierarchical structure. As described above, by utilizing the hierarchical motion vector relation, the motion vector can be predicted more efficiently.

A known method of predicting a motion vector of a lower temporal level using motion vectors of an upper temporal level is the method of the H.264 direct mode.

As shown in FIG. 3, the motion estimation in the direct mode is performed from the upper temporal level to the lower temporal level. Accordingly, a method is used to predict a motion vector having a relatively short reference distance by using motion vectors having a relatively long reference distance. By contrast, since the motion estimation is performed from the lower temporal level in MCTF, motion prediction should also be performed from the lower temporal level to the upper temporal level. Accordingly, the direct mode cannot be directly applied to MCTF.

However, in the case of MCTF, although the motion prediction can be performed from the lower temporal level during the motion estimation, the motion prediction should be performed from the upper temporal level, according to the characteristic of temporal scalability, when the estimated motion vectors are encoded (or quantized) by temporal levels. Accordingly, in the MCTF structure, the direction of the motion prediction that is used during the motion estimation should be opposite to the direction of the motion prediction that is used during the motion vector encoding (or quantization), and thus it is necessary to provide an asymmetric motion prediction method.

### SUMMARY OF THE INVENTION

Accordingly, the present invention has been made to solve the above-mentioned problems occurring in the related art, and an aspect of the present invention is to provide a method that can improve the compression efficiency by efficiently predicting motion vectors using a hierarchical relation when the motion vectors are arranged so as to have a hierarchical arrangement of temporal levels.

Another aspect of the present invention is to provide a method of predicting motion vectors that is suitable for the motion compensated temporal filtering (MCTF) structure, so that an MCTF-based video codec can perform efficient motion estimation and efficient motion vector encoding.

Additional advantages, aspects, and features of the invention will be set forth in part in the description which follows and in part will be apparent to those having ordinary skill in the art upon examination of the following, or may be learned from practice of the invention.

In order to accomplish these objects, there is provided a video encoding method that includes a hierarchical temporal level decomposition process, according to the present invention, which includes the steps of (a) obtaining a predicted motion vector of a second frame, which exists at a present temporal level, from a first motion vector of a first frame that exists at a lower temporal level; (b) obtaining a second motion vector of the second frame by performing a motion estimation in a predetermined motion search area, in consideration of the predicted motion vector as a start point; and (c) encoding the second frame using the obtained second motion vector.

In another aspect of the present invention, there is provided a video encoding method that includes a hierarchical temporal level decomposition process, which includes the steps of (a) obtaining motion vectors of specified frames that exist at a plurality of temporal levels; (b) encoding the frames using the obtained motion vectors; (c) obtaining a predicted motion vector of a second frame, which exists at the present temporal level, from a motion vector of a first frame, which exists at the upper temporal level, among the motion vectors; (d) obtaining a difference between the motion vector of the second frame and the predicted motion vector; and (e) generating a bitstream that includes the encoded frame and the difference.

In still another aspect of the present invention, there is provided a video encoding method that includes a hierarchical temporal level decomposition process, which includes the steps of (a) obtaining motion vectors of specified frames that exist at a plurality of temporal levels; (b) encoding the frames using the obtained motion vectors; (c) obtaining a predicted motion vector of a second frame, which exists at the present temporal level, from a motion vector of a first frame, which exists at the upper temporal level, among the motion vectors, and obtaining a difference between the motion vector of the second frame and the predicted motion vector; (d) obtaining the predicted motion vector of the second frame using neighboring motion vectors in the second frame, and obtaining a difference between the motion vector of the second frame and the predicted motion vector obtained by using the neighboring motion vectors; (e) selecting the difference, which requires a smaller bit amount, between the difference obtained in step (c) and the difference obtain in step (d); and (f) generating a bitstream that includes the encoded frame and the selected difference.

In still another aspect of the present invention, there is provided a video decoding method that includes a hierarchical temporal level restoring process, which includes the steps of (a) extracting texture data of specified frames, which exist at a plurality of temporal levels, and motion vector differences from an input bitstream; (b) restoring a motion vector of a first frame that exists at the upper temporal level; (c) obtaining a predicted motion vector of a second frame, which exists at the present temporal level, from the restored motion vector; (d) restoring a motion vector of the second frame by adding the predicted motion vector to the motion vector difference of the second frame among the motion vector differences; and (e) restoring the second frame by using the restored motion vector of the second frame.

In still another aspect of the present invention, there is provided a video decoding method that includes a hierarchical temporal level restoring process, which includes the steps of (a) extracting a specified flag, texture data of specified frames, which exist at a plurality of temporal levels, and motion vector differences from an input bitstream; (b) restoring a motion vector of a first frame that exists at the upper temporal level; (c) restoring neighboring motion vectors in a second frame that exist at the present temporal level; (d) obtaining a predicted motion vector of the second frame, which exists at the present temporal level, from one of the motion vector of the first frame and the neighboring motion vectors according to the flag value; (e) restoring a motion vector of the second frame by adding the predicted motion vector to the motion vector difference of the second frame among the motion vector differences; and (f) restoring the second frame by using the restored motion vector of the second frame.

In still another aspect of the present invention, there is provided a video encoder that includes a hierarchical temporal level decomposition process, which includes means for obtaining a predicted motion vector of a second frame, which exists at a present temporal level, from a first motion vector of a first frame that exists at a lower temporal level; means for obtaining a second motion vector of the second frame by performing a motion estimation in a predetermined motion search area, in consideration of the predicted motion vector as a start point; and means for encoding the second frame using the obtained second motion vector.

In still another aspect of the present invention, there is provided a video encoder that performs a hierarchical temporal level decomposition process, which includes means for obtaining motion vectors of specified frames that exist at a plurality of temporal levels; means for encoding the frames using the obtained motion vectors; means for obtaining a predicted motion vector of a second frame, which exists at the present temporal level, from a motion vector of a first frame, which exists at the upper temporal level, among the motion vectors; means for obtaining a difference between the motion vector of the second frame and the predicted motion vector; and means for generating a bitstream that includes the encoded frame and the difference.

In still another aspect of the present invention, there is provided a video decoder that performs a hierarchical temporal level restoring process, which includes means for extracting texture data of specified frames, which exist at a plurality of temporal levels, and motion vector differences from an input bitstream; means for restoring a motion vector of a first frame that exists at the upper temporal level; means for obtaining a predicted motion vector of a second frame, which exists at the present temporal level, from the restored motion vector; means for restoring a motion vector of the second frame by adding the predicted motion vector to the motion vector difference of the second frame among the motion vector differences; and means for restoring the second frame by using the restored motion vector of the second frame.

### BRIEF DESCRIPTION OF THE DRAWINGS

The above and other objects, features and advantages of the present invention will become more apparent from the following detailed description taken in conjunction with the accompanying drawings, in which:

FIG. 1 is a view illustrating an encoding process according to 5/3 MCTF;

FIG. 2 is a view explaining a related art method of predicting a motion vector of the present block by using motion vectors of neighboring blocks;

FIG. 3 is a view explaining a related art motion vector prediction method according to a direct mode;

FIG. 4 is a view illustrating an example of a motion search area and an initial point during motion estimation;

FIG. 5 is a view illustrating a first motion prediction method in the case where T(N) is a bidirectional reference and T(N+1) is a forward reference;

FIG. 6 is a view illustrating a first motion prediction method in the case where T(N) is a forward reference and T(N+1) is a forward reference;

FIG. 7 is a view illustrating a first motion prediction method in the case where T(N) is a backward reference and T(N+1) is a forward reference;

FIG. 8 is a view illustrating a first motion prediction method in the case where T(N) is a bidirectional reference and T(N+1) is a backward reference;

FIG. 9 is a view illustrating a first motion prediction method in the case where T(N) is a forward reference and T(N+1) is a backward reference;

FIG. 10 is a view illustrating a first motion prediction method in the case where T(N) is a backward reference and T(N+1) is a backward reference;

FIG. 11 is a view explaining a method of setting the corresponding position of a motion vector during the first motion prediction;

FIG. 12 is a view explaining a method of predicting a motion vector after a non-coincident temporal position is compensated for in the method of FIG. 11;

FIG. 13 is a view illustrating a second motion prediction method in the case where T(N+1) is a forward reference;

FIG. 14 is a view illustrating a second motion prediction method in the case where T(N+1) is a backward reference;

FIG. 15 is a view explaining a method of setting the corresponding position of a motion vector during the second motion prediction;

FIG. 16 is a block diagram illustrating the construction of a video encoder according to an embodiment of the present invention;

FIG. 17 is a block diagram illustrating the construction of a video decoder according to an embodiment of the present invention;

FIG. 18 is a view illustrating the construction of a system for operating the video encoder or video decoder according to an embodiment of the present invention;

FIG. 19 is a flowchart illustrating a video encoding method according to an embodiment of the present invention; and

FIG. 20 is a flowchart illustrating a video decoding method according to an embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the whole description of the present invention, the same drawing reference numerals are used for the same elements across various figures.

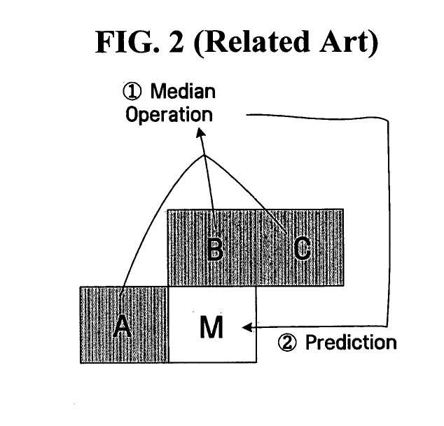

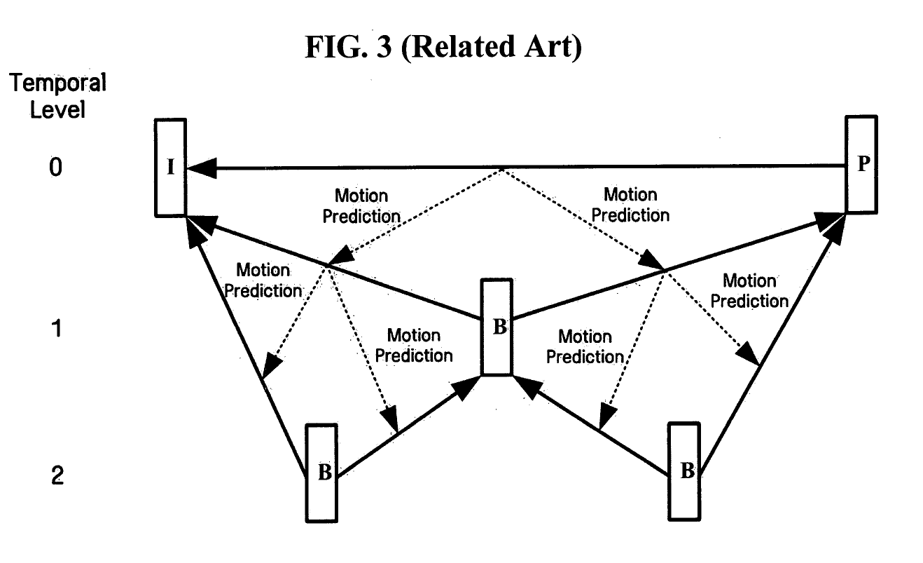

A related art method of predicting a motion vector of the present block by using motion vectors of neighboring blocks, as illustrated in FIG. 2, predicts a motion vector only by considering motion vectors of adjacent blocks of the same frame, without considering the correlation between motion vectors obtained at different temporal levels. In the present invention, however, a method is proposed to predict a motion vector by using the similarity between the motion vectors of different temporal levels. In the present invention, the motion prediction is performed in two steps. That is, motion prediction is used in a step of deciding the initial point for a motion search and optimum motion vectors during motion estimation, and in a motion vector encoding step that obtains a difference between an actual motion vector and a motion predicted value. As described above, different motion prediction methods are used in the two steps due to the characteristics of motion compensated temporal filtering (MCTF).

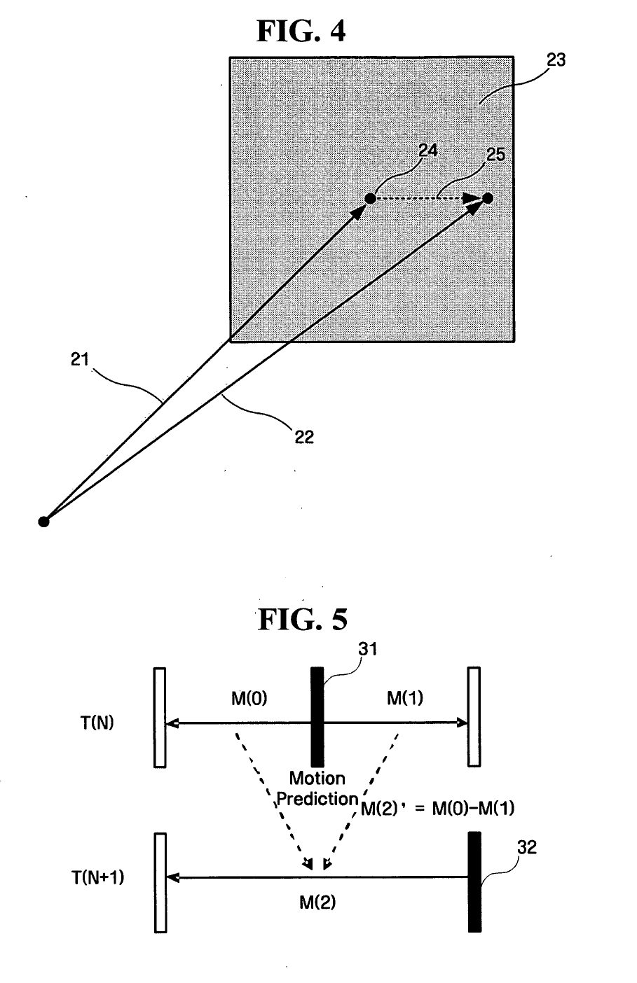

FIG. 4 is a view illustrating an example of a motion search area 23 and an initial point 24 during motion estimation. Methods of searching for a motion vector can be classified into a full area search method for searching for motion vectors in a whole frame and a local area search method for searching got motion vectors in a predetermined search area. The motion vector is used to reduce a texture difference by adopting a more similar texture block. However, since the motion vector is a part of the data that should be transmitted to a decoder, and since a lossless encoding method is mainly used, a considerable number of bits are allocated to the motion vector. Accordingly, a reduction of the number of bits for the motion vector, no less than the number of bits for texture data, may be important for improving the video compression performance. Accordingly, most recent video codecs limit the magnitude of the motion vector by mainly using the local area search method.

If the motion vector search is performed within the motion search area 23 with a more accurately predicted motion vector 24 provided as an initial value, the amount of calculation required for the motion vector search can be reduced, and the difference 25 between the predicted motion vector (or predicted value of the motion vector) and the actual motion vector can be reduced.

The motion prediction method used in the motion estimation step, as described above, is called the first motion prediction method.

Also, the motion prediction method according to the present invention is applied in a step of encoding the found motion vector. Although, according to the related art motion prediction methods, the motion prediction method used in the motion estimation step is also used in the motion vector encoding step, and the same motion prediction method cannot be used in both steps due to the characteristics of the MCTF.

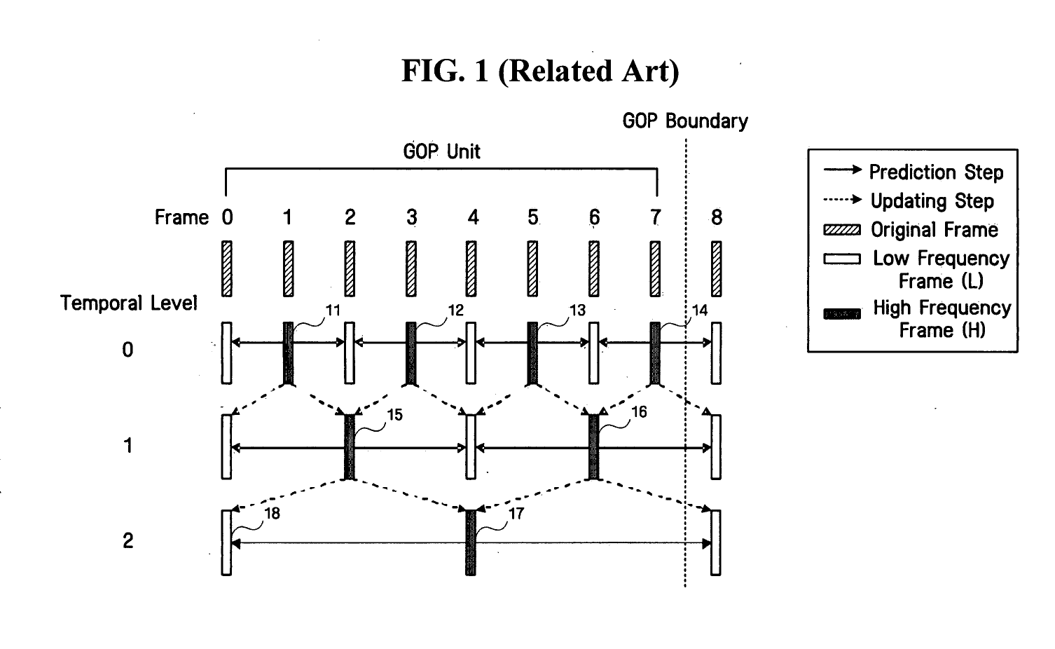

Referring to FIG. 1, since the temporal level decomposition process of MCTF is performed from a lower temporal level to an upper temporal level, during the motion estimation it is necessary to predict a motion vector having a long reference distance by using a motion vector having a short reference distance. However, due to the characteristics of the temporal scalability of MCTF, frames 17 and 18 of the uppermost temporal level must be transmitted, but frames 11 to 16 of other levels are selectively transmitted. Accordingly, unlike the motion estimation step, it is necessary to predict motion vectors of frames of lower temporal levels on the basis of the motion vectors of the frames of the uppermost temporal levels. Thus, the direction of the motion prediction in the motion vector encoding step is opposite to that of the motion prediction in the motion estimation step. The motion prediction method used in the motion vector encoding step is called the second motion prediction method to distinguish it from the first motion prediction method.

### First Motion Prediction Method of Motion Estimation Step

As described above, the first motion prediction method predicts a motion vector having a long reference distance using a motion vector having a short reference distance (i.e., the temporal distance between a referred frame and a referring frame). However, even in 5/3 MCTF, which permits a bidirectional reference, the bidirectional reference is not necessarily adopted, but a reference that requires a small number of bits can be selected among a bidirectional reference, a backward reference, and a forward reference. Accordingly, six possible cases may appear during the prediction of motion vectors between temporal levels, as shown in FIGS. 5 to 10.

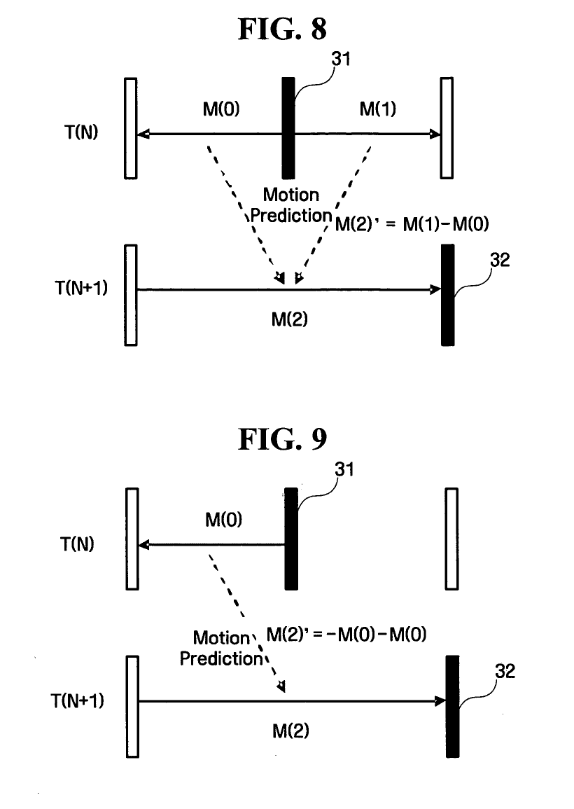

FIGS. 5 to 10 are views explaining the first motion prediction method. Among them, FIGS. 5 to 7 show the cases where motion vectors are predicted by the forward reference (i.e., by referring to the temporally previous frame), and FIGS. 8 to 10 show the cases where motion vectors are predicted by backward reference (i.e., by referring to the temporally following frame).

In the following description, T(N) denotes the N-th temporal level, M(0) and M(1) denote motion vectors searched for at T(N), and M(2) denotes a motion vector searched for at T(N+1). Also, M(0)′, M(1)′, and M(2)′ denote motion vectors predicted for M(0), M(1), and M(2), respectively.

In most cases, an object moves in a constant direction at a constant speed. This is especially true in the case where a background constantly moves or a specified object is observed for a short time. Accordingly, it can be assumed that M(0)-M(1) is similar to M(2). Accordingly, M(2)′, which is the predicted motion vector of M(2), can be defined by Equation (1).
M(2)′=M(0)−M(1) (1)

Since M(0) is in the same direction as M(2), it is added in a positive direction, and since M(1) is in an opposite direction to M(2), it is added in a negative direction.

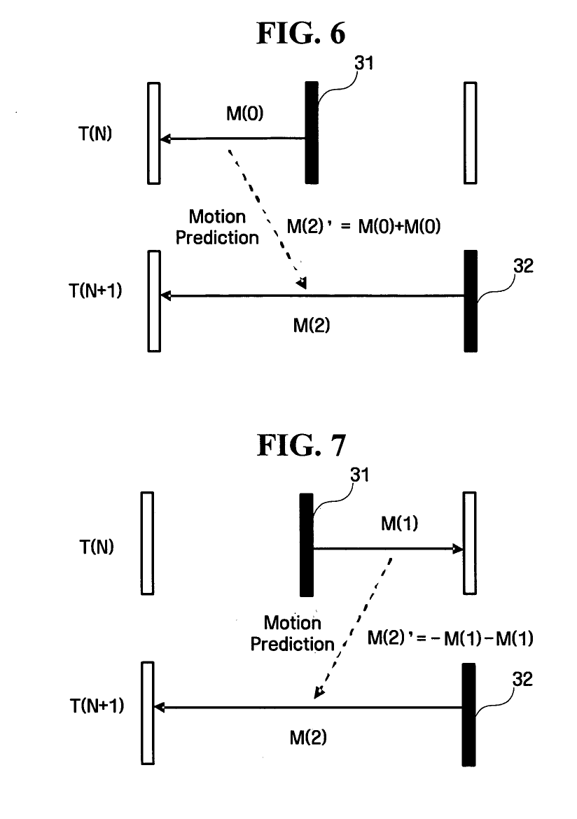

FIG. 6 is a view illustrating a first motion prediction method in the case where T(N) is a forward reference and T(N+1) is a forward reference. In this case, the motion vector M(2) of a frame 32 at T(N+1) is predicted from the forward motion vector M(0) of a frame 31 at T(N). At this time, the predicted motion vector M(2)′ of M(2) can be defined as in Equation (2).
M(2)′=2×M(0) (2)

Equation (2) considers that M(2) is in the same direction as M(0), and the reference distance of M(2) is twice the reference distance of M(0).

FIG. 7 is a view illustrating a first motion prediction method in the case where T(N) is a backward reference and T(N+1) is a forward reference. In this case, the motion vector M(2) of the frame 32 at T(N+1) is predicted from the backward motion vector M(1) of the frame 31 at T(N). At this time, the predicted motion vector M(2)′ of M(2) can be defined as in Equation (3).
M(2)′=−2×M(1) (3)

Equation (3) considers that M(2) is in the opposite direction to M(1), and the reference distance of M(2) is twice the reference distance of M(1).

FIG. 8 is a view illustrating a first motion prediction method in the case where T(N) is a bidirectional reference and T(N+1) is a backward reference. In this case, the motion vector M(2) of the frame 32 at T(N+1) is predicted from the motion vectors M(0) and M(1) of the frame 31 at T(N). At this time, the predicted motion vector M(2)′ of M(2) can be defined as in Equation (4).
M(2)′=M(1)−M(0) (4)

Since M(1) is in the same direction as M(2), it is added in a positive direction, and since M(0) is in an opposite direction to M(2), it is added in a negative direction.

FIG. 9 is a view illustrating a first motion prediction method in the case where T(N) is a forward reference and T(N+1) is a backward reference. In this case, the motion vector M(2) of the frame 32 at T(N+1) is predicted from the backward motion vector M(0) of the frame 31 at T(N). At this time, the predicted motion vector M(2)′ of M(2) is defined by Equation (5).
M(2)′=−2×M(0) (5)

Equation (5) takes into account that M(2) is in the opposite direction to M(0), and the reference distance of M(2) is twice the reference distance of M(0).

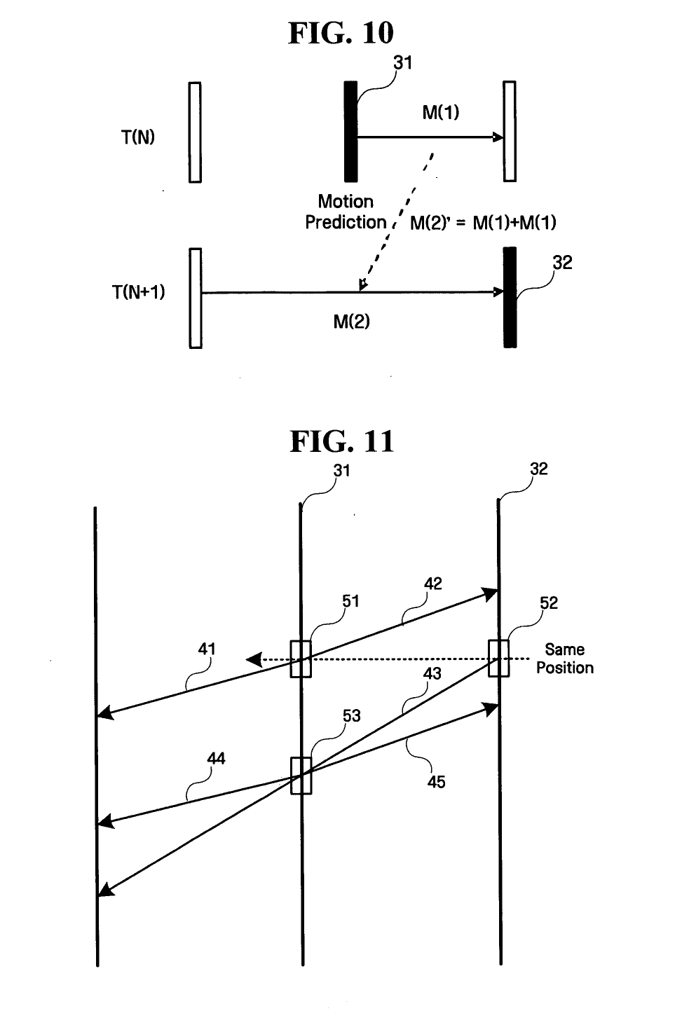

FIG. 10 is a view illustrating a first motion prediction method in the case where T(N) is a backward reference and T(N+1) is a backward reference. In this case, the motion vector M(2) of the frame 32 at T(N+1) is predicted from the backward motion vector M(1) of the frame 31 at T(N). At this time, the predicted motion vector M(2)′ of M(2) is defined by Equation (6).
M(2)′=2×M(1) (6)

Equation (6) takes into account that M(2) is in the same direction as M(1), and the reference distance of M(2) is twice the reference distance of M(1).

As described above, FIGS. 5 to 10 illustrate diverse cases where the motion vector of the upper temporal level is predicted from the motion vectors of the lower temporal level. However, since temporal positions of the lower temporal level frame 31 and the upper temporal level frame 32 are not consistent with each other, a problem may arise about whether the motion vectors at different positions correspond to each other.

This problem can be solved by several methods. First, a method of making the motion vectors of the blocks at the same position correspond to each other can be used. In this case, the prediction may be somewhat inaccurate since the temporal positions of both frames 31 and 32 are not consistent with each other. However, in the case of a video sequence that has no abrupt motion change, a sufficiently good effect can be obtained. Referring to FIG. 11, motion vectors 41 and 42 of a certain block 51 in the frame 31 of a lower temporal level can be used to predict a motion vector 43 of a block 52 at the same position as the block 51 in the frame 32 of an upper temporal level.

A method of predicting the motion vector after correcting an inconsistent temporal position can also be used. In FIG. 11, in accordance with a profile of a motion vector 43 of a certain block 52 in the frame 32 of an upper temporal level, the motion vectors 44 and 45 of a corresponding area 53 in the frame 31 of a lower temporal level can be used to predict the motion vector 43. However, the area 53 may not be consistent with the blocks to which the motion vectors are allocated, respectively, but the representative motion vectors 44 and 45 can be obtained by obtaining an area weighted average or a median value.

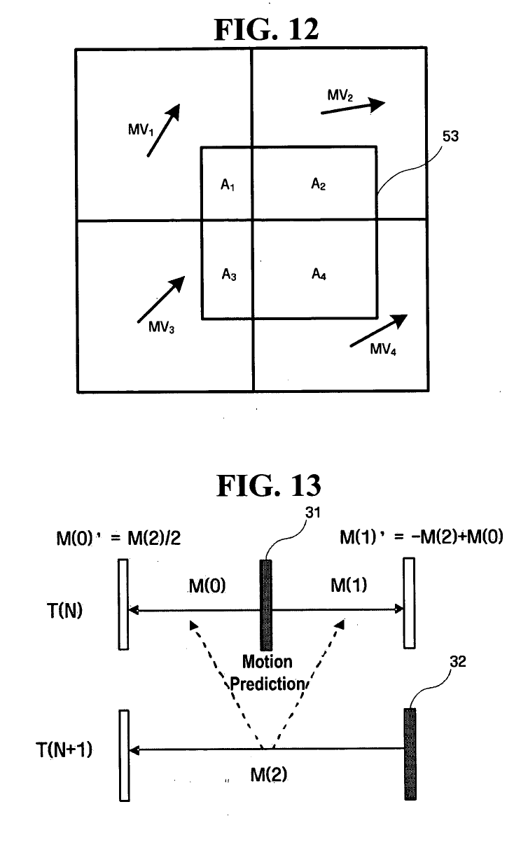

For example, assuming that the area 53 is put at a position where the area overlaps four blocks, as illustrated in FIG. 12, the motion vector (MV) of the area 53 can be obtained by Equation (7) in the case of using the area weighted average, and by Equation (8) in the case of using the median. In the bidirectional reference case, two types of motion vectors exist in the blocks, and thus, operation is performed with respect to the respective motion vectors.

$$\begin{matrix}MV = \frac{{\sum }_{i = 1}^{4} {A}_{i} \times {MV}_{i}}{{\sum }_{i = 1}^{4} {A}_{i}} & ( 7 ) \\ MV = medium ( {MV}_{i} ) & ( 8 )\end{matrix}$$

If the predicted motion vector M(2)′ is obtained through the above-described process, the motion estimation can be performed using the obtained predicted motion vector. Referring to FIG. 4, when the motion prediction is performed at T(N+1) by using the obtained predicted motion vector M(2)′, an initial point 24 for the motion vector search is set. Then, the optimum motion vector 25 is searched for as the motion search area 23 moves from the initial point 24.

The optimum motion vector 25 means a motion vector whereby a cost function C (Equation 9) is minimized in the motion search area 23. Here, E denotes a difference between a texture of a specified block in the original frame and a texture of the corresponding area in the reference frame, Δ denotes the difference between the predicted motion vector and a certain motion vector in the motion search area, and λ denotes a Lagrangian multiplier, which is a coefficient capable of adjusting the reflection rate of E and Δ.
C=E+λ×Δ (9)

As described above, the temporary motion vector is a motion vector randomly selected in the motion search area 23, and one among plural temporary motion vectors is selected as the optimum motion vector 25.

In the case of performing motion estimation with respect to a fixed size block, only the optimum motion vector 25 is set through the cost function of Equation (9). However, in the case of performing motion estimation with respect to a variable size block, both the optimum motion vector 25 and a macroblock pattern are set.

### Second Motion Prediction Method of Motion Vector Encoding Step

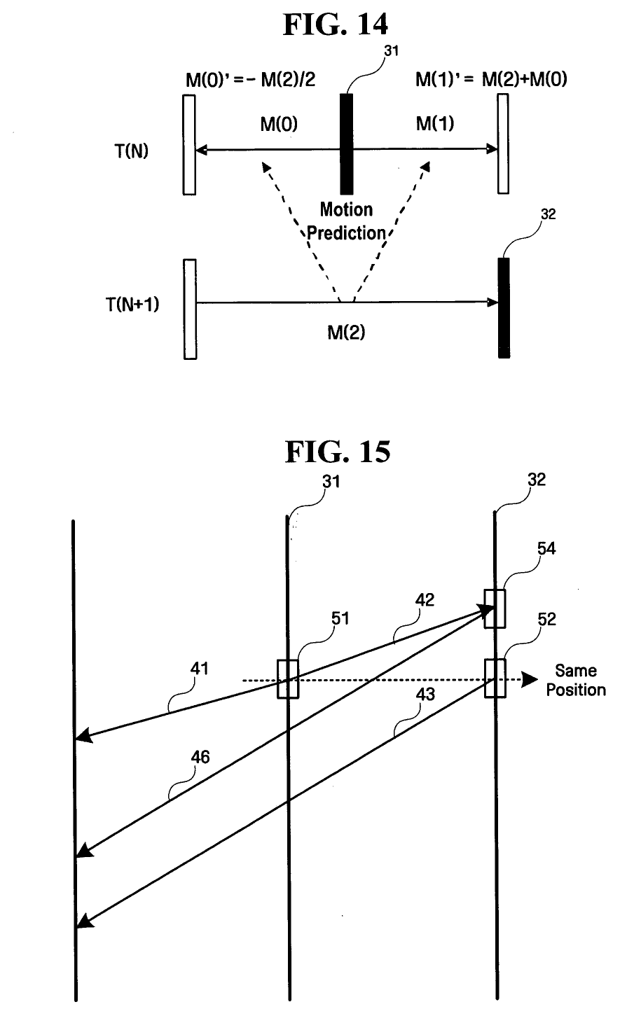

As described above, the second motion prediction predicts a motion vector having a short reference distance using a motion vector having a long reference distance. FIG. 13 is a view illustrating a second motion prediction method in the case where the frame 32 of the upper temporal level refers to a forward reference, and FIG. 14 is a view illustrating a second motion prediction method in the case where the frame 32 refers to a backward reference.

Referring to FIG. 13, motion vectors M(0) and M(1) of the frame 31 at T(N) are predicted by a forward motion vector M(2) of the frame 32 at T(N+1).

In most cases, an object moves in a constant direction at a constant speed. This is especially true in the case where a background constantly moves or a specified object is observed for a short time. Accordingly, it can be assumed that M(0)-M(1) is similar to M(2). Actually, it is frequently found that M(0) and M(1) have different directions, but their absolute values are similar. This is because the speed of an object does not greatly change in a short time period. Accordingly, M(0)′ and M(1)′ can be defined by Equation (10).
M(0)′=M(2)/2
M(1)′=−M(2)+M(0) (10)

In Equation (10), it can be recognized that M(0) is predicted by using M(2), and M(1) is predicted by using M(0) and M(2). However, M(0) or M(1) may not exist at T(N). This is because the video codec selects the most suitable one among forward, backward, and bidirectional references according to the compression efficiency. If only the backward reference exists at T(N), i.e., if M(0) does not exist and only M(1) exists, it is impossible to obtain M(1)′ from Equation (10). In this case, since it is assumed that M(0) is similar to −M(1), M(1)′ can be expressed as in Equation (11)
M(1)′=−M(2)+M(0)=−M(2)−M(1) (11)

In this case, the difference between M(1) and its predicted value M(1)′: 2×M(1)+M(2).

Next, referring to FIG. 14, motion vectors M(0) and M(1) of the frame 31 at T(N) are predicted by a backward motion vector M(2) of the frame 32 at T(N+1). In this case, M(0)′ and M(1)′ can be defined as in Equation (12).
M(0)′=−M(2)/2
M(1)′=M(2)+M(0) (12)

In Equation (12), M(0) is predicted by using M(2), and M(1) is predicted by using M(0) and M(2). If only the backward reference exists at T(N), i.e., if M(0) does not exist and only M(1) exists, it is impossible to obtain M(1)′ from Equation (12), and M(1)′ can be modified as in Equation (13).
M(1)′=M(2)+M(0)=M(2)−M(1) (13)

In Equations (10) and (12), M(0) is predicted by using M(2), and M(1) is predicted by using M(0) and M(2). However, a method of predicting M(1) by using M(2), and predicting M(0) by using M(1) and M(2) can also be used. According to this method, M(0)′ and M(1)′, as illustrated in FIG. 13, are defined by Equation (14).
M(1)′=−M(2)/2
M(0)′=M(2)+M(1) (14)

In the same manner, M(0)′ and M(1)′, as illustrated in FIG. 14, can be defined by Equation (15).
M(1)′=M(2)/2
M(0)′=−M(2)+M(1) (15)

As described above, FIGS. 13 and 14 illustrate diverse cases where the motion vector of the lower temporal level is predicted through the motion vectors of the upper temporal level. However, since temporal positions of the lower temporal level frame 31 and the upper temporal level frame 32 are not consistent with each other, a problem may arise as to whether the motion vectors at different positions correspond to each other. However, this problem can be solved in the same manner as the first motion prediction method by the following methods.

First, a method of making the motion vectors of the blocks at the same position correspond to each other can be used. Referring to FIG. 15, a motion vector 43 of a certain block 52 in the frame 32 of an upper temporal level can be used to predict motion vectors 41 and 42 of a block 51 at the same position as the block 52 in the frame 31 of a lower temporal level.

Next, a method of predicting the motion vector after correcting an inconsistent temporal position can be used. In FIG. 15, in accordance with a profile of a backward motion vector 42 of a certain block 51 in the frame 31 of a lower temporal level, the motion vector 46 of a corresponding area 54 in the frame 32 of an upper temporal level can be used to predict the motion vectors 41 and 43. However, the area 54 may not be consistent with the blocks to which the motion vectors are allocated, and one representative motion vector 46 can be obtained by obtaining an area weighted average or a median value. The area weighted average or the median value can be obtained by Equations (7) and (8).

If the predicted motion vectors M(0)′ and M(1)′ are obtained through the above-described process, the motion vectors can be efficiently compressed using the obtained predicted motion vectors. That is, the number of bits required for the motion vectors can be reduced by transmitting a motion vector difference M(1)−M(1)′, instead of M(1), and transmitting M(0)−M(0)′, instead of M(0). In the same manner, the motion vector at a lower temporal level, i.e., T(N−1), can be predicted/compressed by using a temporally closer motion vector between M(0) and M(1).

### The Case of Different Reference Distances

Even in MCTF, a forward reference distance and a backward reference distance may differ. This may occur in the MCTF that supports the multiple reference, and in this case, M(0)′ and M(1)′ can be calculated by considering weight values.

For example, if the left reference frame is one step apart and the right reference frame is two steps apart at the temporal level N in FIG. 13, M(0)′ in Equation (10) should be calculated as M(2)□⅔, instead of M(2)/2, in proportion to the reference distance. In this case, the equation for calculating M(1)′ does not change. In the case of using Equation (11), M(1)′ is: −M(2)×⅔.

Generally, if M(2) is a forward motion vector, as in FIG. 13, the predicted motion vector M(0)′ for the forward motion vector M(0) is obtained according to a related equation of M(0)′32 a×M(2)/(a+b), and the predicted motion vector M(1)′ for the backward motion vector M(1) is obtained according to a related equation: M(1)′=−M(2)+M(0). Here, a denotes a forward distance rate, and is a value obtained by dividing the forward reference distance by the sum of the forward reference distance and the backward reference distance. Also, b denotes a backward distance rate, and is a value obtained by dividing the backward reference distance by the sum of the forward reference distance and the backward reference distance.

In the same manner, if M(2) is a backward motion vector, as in FIG. 14, the predicted motion vector M(0)′ for the forward motion vector M(0) is obtained according to the equation: M(0)′=−a×M(2)/(a+b), and the predicted motion vector M(1)′ for the backward motion vector M(1) is obtained according to the equation: M(1)′=M(2)+M(0).

### Adaptive Use of the Related Art Spatial Motion Prediction Method and Motion Prediction Method between Temporal Levels

The related art spatial motion prediction method is advantageous when a pattern of adjacent motion vectors is constant in the same frame, and the motion prediction method proposed according to the present invention is advantageous when motion vectors are temporally constant. Particularly, in comparison to the spatial motion prediction method, the motion prediction method proposed according to the present invention can improve the efficiency in parts (e.g., an object boundary) where the pattern of the adjacent motion vectors in the same frame changes greatly.

In contrast, in the case where the motion vectors are temporally changed, the proposed motion prediction method may have a low efficiency in comparison to the spatial motion prediction method. In order to solve this problem, a one-bit flag is inserted in a slice or a macroblock in order to select the better method of the two (related art or proposed).

If the flag “motion_pred_method_flag” is “0”, the motion vector difference is obtained using the related art spatial motion prediction method, but if the flag “motion_pred_method_flag” is “1”, the motion vector difference is obtained using the method proposed according to the present invention. In order to select the better method, the obtained motion vector difference is actually encoded (i.e., lossless-encoded), and the method that consumes less bits is selected to perform the motion prediction.

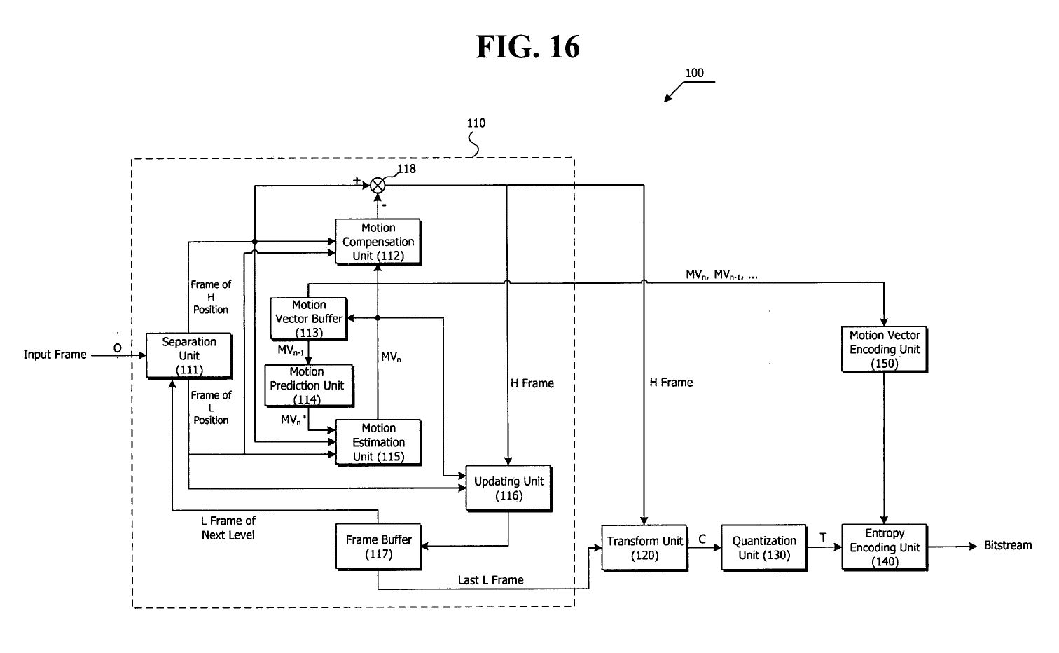

Hereinafter, the construction of a video encoder and a video decoder for implementing the methods proposed in the present invention will be explained. FIG. 16 is a block diagram illustrating the construction of a video encoder 100 according to an exemplary embodiment of the present invention. The video encoder 100 includes a temporal level decomposition process according to the hierarchical MCTF.

Referring to FIG. 16, a separation unit 111 separates an input frame O into a frame of a high frequency frame position (H position) and a frame of a low frequency frame position (L position). In general, the high frequency frame is positioned at an odd-numbered position 2i+1, and the low frequency frame at an even-numbered position 2i. Here, “i” denotes an index representing a frame number, and has an integer value that is larger than zero. The frames at the H position pass through a temporal prediction process (here, the temporal prediction means texture prediction, not motion vector prediction), and frames at the L position pass through an updating process.

The frame at the H position is inputted to a motion estimation unit 115, a motion compensation unit 112, and a subtracter 118.

The motion estimation unit 113 obtains a motion vector by performing a motion estimation on a frame at the H position (hereinafter referred to as a “present frame”) with reference to neighboring frames (frames at the same temporal level but at different temporal positions). The neighboring frames described above are called “reference frames”.

If the present temporal level is “0”, no lower temporal level exists, and the motion estimation is performed irrespective of motion vectors of different temporal levels. In general, a block matching algorithm is widely used for the motion estimation. In other words, as a given block is moving in the unit of a pixel or a sub-pixel (i.e., ¼ pixel) in a predetermined search area of a reference frame, the displacement with minimal error is chosen as the motion vector. For the motion estimation, a fixed block matching method or a hierarchical method using a hierarchical variable size block matching (HVSBM) algorithm may be used.

If the present temporal level is not “0”, a lower temporal level exists, and the motion prediction is performed at the present temporal level by using the motion vector obtained at the lower temporal level before the motion estimation is performed. This motion vector prediction process is performed by a motion prediction unit 114.

The motion prediction unit 114 predicts a motion vector MVₙ′ at the present temporal level by using a motion vector MVₙ₋₁ at a lower temporal level provided from a motion vector buffer 113, and provides the predicted motion vector to the motion estimation unit 115. The process of obtaining the predicted motion vector has been explained with reference to FIGS. 5 to 10, and therefore the explanation thereof is omitted. MVₙ corresponds to M(2) in FIGS. 5 to 10, MVₙ′ corresponds to M(2)′, and MVₙ₋₁ corresponds to M(0) or M(1).

If the predicted motion vector is obtained as described above, the motion estimation unit 115 performs the motion estimation in a predetermined motion search area at the initial point represented by the predicted motion vector. During the motion estimation, an optimum motion vector can be chosen by obtaining the motion vector having the minimum cost function among temporary motion vectors, as explained in Equation (9), and an optimum macroblock pattern can also be chosen in the case where HVSBM is used.

The motion vector buffer 113 stores the optimum motion vector at the corresponding temporal level, which has been obtained by the motion estimation unit 115, and provides the optimum motion vector to the motion prediction unit 114 when the motion prediction unit 114 predicts the motion vector at an upper temporal level.

The motion vector MVₙ at the present temporal level (decided by the motion estimation unit 115) is then provided to the motion compensation unit 112.

The motion compensation unit 112 generates a motion compensated frame for the present frame by using the obtained motion vector MVₙ and the reference frame. The subtracter 118 obtains the difference between the present frame and the motion compensation frame provided by the motion compensation unit 112, and generates a high frequency frame (H frame). The high frequency frame is called a residual frame. The generated high frequency frames are provided to an updating unit 116 and a transform unit 120.

The updating unit 116 updates frames at an L position using the generated high frequency frames. In the case of 5/3 MCTF, a certain frame at the L position is updated by using two temporally adjacent high frequency frames. If a unidirectional (e.g., forward or backward) reference is used in the process of generating the high frequency frame, the updating process may be unidirectionally performed in the same manner. Detailed equations of the MCTF updating process are well known in the art, and thus, a detailed explanation thereof is omitted.

The updating unit 116 stores the updated frames at the L position in a frame buffer 117, and the frame buffer 117 provides the stored frame at the L position to the separation unit 111 for the MCTF decomposition process at the upper temporal level. However, if the frame at the L position is the last L frame, an upper temporal level does not exist, and the frame buffer provides the final L frame to the transform unit 120.

The separation unit 111 separates the frames provided from the frame buffer 117 into frames at an H position and frames at an L position at an upper temporal level. Then, a temporal prediction process and an updating process are performed at the upper temporal level. The MCTF decomposition process can be repeated until the last L frame remains.

The transform unit 120 performs a spatial transform and generates transform coefficients C for the provided last L frame and the H frame. A discrete cosine transform (DCT) or a wavelet transform may be used as the spatial transform method. In the case of using the DCT, the transform coefficient will be a DCT coefficient, and in the case of using the wavelet transform, the transform coefficient will be a wavelet coefficient.

A quantization unit 130 quantizes the transform coefficient C. The quantization refers to a process of representing the transform coefficient expressed as a real number as a discrete value. For example, the quantization unit 130 divides the transform coefficient in specified quantization steps, and performs the quantization in such a manner that the result of division is rounded off to an integer value. The quantization steps can be provided from a predefined quantization table.

A motion vector encoding unit 150 receives motion vectors MVₙ and MVₙ₋₁ at the respective temporal levels from the motion vector buffer 113, and obtains the motion vector differences at the temporal levels, except for the uppermost temporal level. The motion vector encoding unit 150 sends the obtained motion vector differences and the motion vector at the uppermost temporal level to an entropy encoding unit 140.

The process of obtaining the motion vector difference, which has already been explained with reference to FIGS. 13 and 14, will be briefly explained. First, the motion vector at the present temporal level is predicted using the motion vector at an upper temporal level. The motion vector can be predicted using Equations (10) and (11). Then, the difference between the motion vector at the present temporal level and the predicted motion vector is obtained. The difference as calculated above is called a motion vector difference for the temporal level.

It may be preferable in terms of coding efficiency to provide the motion vector at the uppermost temporal level to the entropy encoding unit 140 in the form of a difference by using the related art spatial motion prediction method as illustrated in FIG. 2, rather than to provide the motion vector in a non-encoded state.

The entropy encoding unit 140 generates a bitstream by performing a lossless coding of the results T of quantization by the quantization emit 130, the motion vector at the uppermost temporal level provided by the motion vector encoding unit 150, and the motion vector differences for other temporal levels. Huffman coding, arithmetic coding, variable length coding, and others may be used as the lossless coding method.

In another embodiment of the present invention, the related art spatial motion prediction method and the motion prediction method between the temporal levels proposed according to the present invention may be used together. In this case, the motion vector encoding unit 150 selects either the motion vector at the present temporal level, which is predicted from the motion vector at the lower temporal level, or the motion vector predicted from the neighboring motion vector, and encodes the selected predicted motion vector. That is, the motion vector encoding unit 150 performs a lossless coding of the difference between the motion vector predicted from the motion vector at the lower temporal level and the motion vector at the present temporal level (first difference), and the difference between the motion vector predicted from the neighboring motion vector and the motion vector at the present temporal level (second difference), and selects the one with the smaller number of bits.

This adaptive motion vector encoding system permits different motion prediction systems in the unit of a frame, a slice, and a macroblock. In order for the video decoder to recognize the result of the above selection, a one-bit flag “motion_pred_method_flag” may be written in a frame header, a slice header, or a macroblock header. For example, if “motion_pred_method_flag” is “0”, the related art spatial motion prediction method has been used, while if “motion_pred_method_flag” is “1”, the related art spatial motion prediction method between the temporal levels has been used to obtain the motion vector difference.

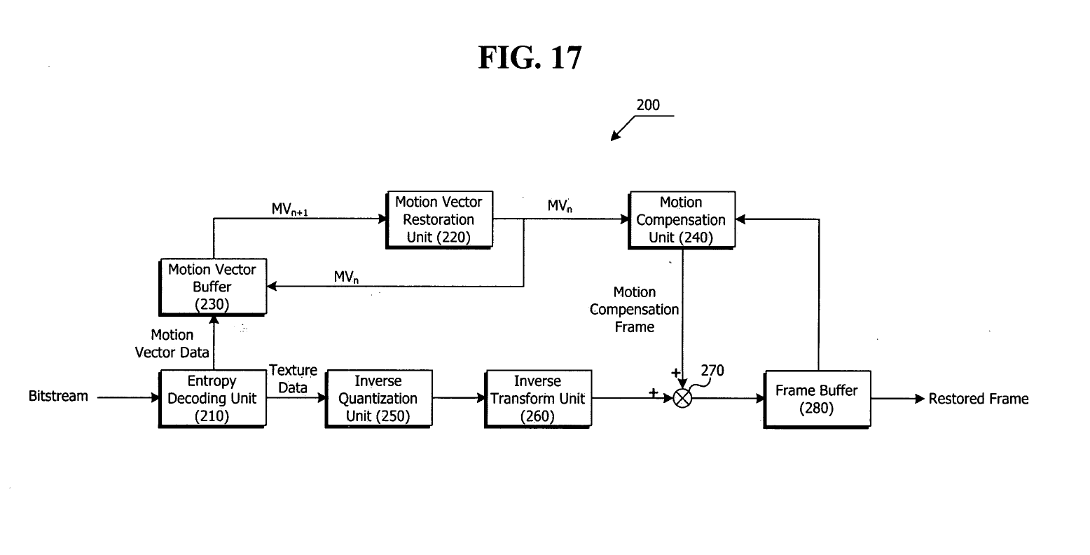

FIG. 17 is a block diagram illustrating the construction of a video decoder 200 according to an embodiment of the present invention. The video decoder includes a temporal level restoring process according to hierarchical MCTF.

An entropy decoding unit 210 performs lossless decoding, and extracts texture data of the respective frames and motion vector data at the respective temporal levels from an input bitstream. The motion vector data includes motion vector differences for the respective temporal levels. The extracted texture data is provided to an inverse quantization unit 250, and the extracted motion vector data is provided to a motion vector buffer 230.

A motion vector restoration unit 220 obtains predicted motion vectors in the same manner as the motion vector encoding unit 150 of the video encoder 100, and restores the motion vectors of the respective temporal levels by adding the obtained predicted motion vectors and the motion vector differences. The method of obtaining the predicted motion vectors is as described above with reference to FIGS. 13 and 14. That is, the predicted motion vector is obtained by predicting the motion vector MVₙ at the present temporal level by using the motion vector MVₙ₊₁ at the upper temporal level, which has been restored in advance and stored in the motion vector buffer 230, and the motion vector MVₙ at the present temporal level is restored by adding the predicted motion vector to the motion vector difference for the present temporal level. Then, the restored motion vector MVₙ is re-stored in the motion vector buffer 230.

In the case where the video encoder 100 has used the adaptive motion vector encoding method, the motion vector restoration unit 220 generates the predicted motion vector according to the spatial motion prediction method if the confirmed “motion_pred_method_flag” is “0”, and it generates the predicted motion vector according to the motion prediction method between the temporal levels as illustrated in FIGS. 13 and 14 if the confirmed “motion_pred_methd_flag” is “1”. The motion vector MVₙ at the present temporal level can be restored by adding the generated predicted motion vector to the motion vector difference. This adaptive motion prediction process can be performed in the unit of a frame, a slice, or a macroblock, as needed.

An inverse quantization unit 250 inversely quantizes the texture data provided by the entropy decoding unit 210. In the inverse quantization process, values that match indexes generated in the quantization process are restored using the same quantization table as that used in the quantization process.

An inverse transform unit 260 performs inverse transform of the results of inverse quantization. Such inverse transform is performed through a method corresponding to the method of the transform unit 120 of the video encoder 100 side, and may employ the inverse DCT transform, inverse wavelet transform, and others. The result of the inverse transform, i.e., the restored high frequency frame, is send to an adder 270.

A motion compensation unit 240 generates the motion compensated frame using the motion vector at the present temporal level (provided by the motion vector restoration unit 220) and the reference frame (previously restored and stored in the frame buffer 280) for the high frequency frame at the present temporal level, and provides the generated motion compensated frame to the adder 270.

The adder 270 restores a certain frame at the present temporal level by adding the provided high frequency frame to the motion compensated frame, and stores the restored frame in the frame buffer 280.

The motion compensation process of the motion compensation unit 240 and the adding process of the adder 270 are repeated until all the frames from the uppermost temporal level to the lowermost temporal level are restored. The restored frame that is stored in the frame buffer 280 can be visually outputted through a display device.

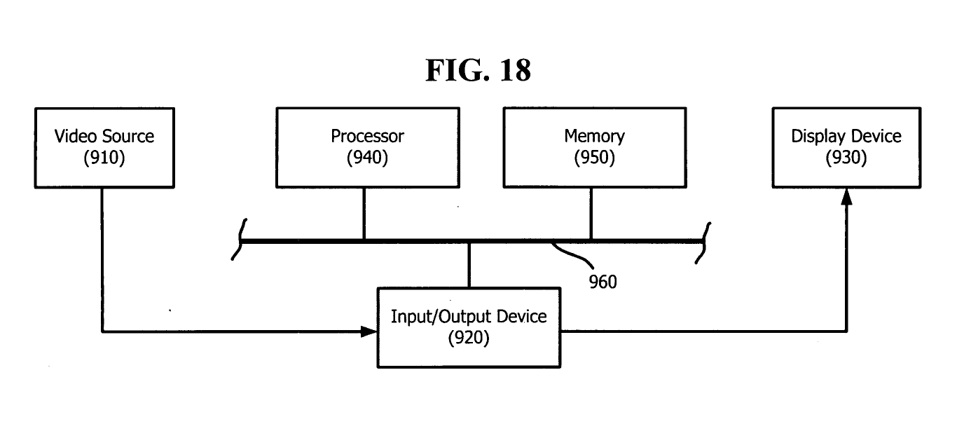

FIG. 18 is a diagram illustrating the construction of a system for performing an operation of the video encoder 100 or the video decoder 300 according to an embodiment of the present invention. The system may employ a television (TV) receiver, a set top box, a desktop computer, a laptop computer, a palmtop computer, a personal digital assistant (PDA), or a video or image storage device (e.g., video cassette recorder (VCR) and or a digital video recorder (DVR)). Further, the system may also be a combination of the above devices, or a device partially included in other devices. The system may include at least one video source 910, at least one input/output device 920, a processor 940, a memory 950, and a display device 930.

The video source 910 may be a TV receiver, a VCR, or another video storage device. Further, the video source 910 may be at least one network connection for receiving a video from a server using Internet, a wide area network (WAN), a local area network (LAN), a terrestrial broadcast system, a cable network, a satellite communication network, a wireless network, or a telephone network. Further still, the source may be a combination of the networks, or a network partially included in other networks.

The input/output device 920, the processor 940, and the memory 950 communicate through a communication medium 960. The communication medium 960 may be a communication bus, a communication network, or at least one internal connection circuit. Video data received from the video source 910 may be processed by the processor 940 according to at least one software program stored in the memory 950, and may be executed by the processor 940 in order to generate an output video to be provided to the display device 930.

In particular, a software program stored in the memory 950 may include a scalable video codec for executing the method according to the present invention. The encoder or the codec may be stored in the memory 950, and may be read from a storage medium such as a CD-ROM or a floppy disk, or may be downloaded from a predetermined server through various kinds of networks. The software program may be replaced with a hardware circuit, or a combination of the software and the hardware circuit.

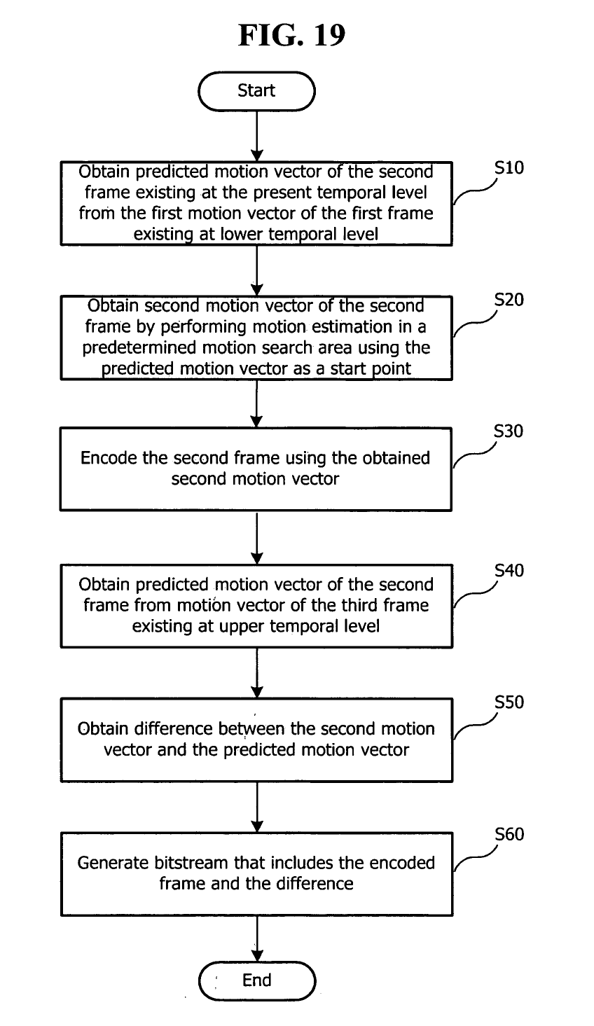

FIG. 19 is a flowchart illustrating a video encoding method according to an exemplary embodiment of the present invention.

First, the motion prediction unit 114 obtains a predicted motion vector of the second frame that exists at the present temporal level from the first motion vector of the first frame S10. Here, the lower temporal level means a temporal level that is one step lower than the present temporal level. The process of obtaining the predicted motion vector has been explained with reference to FIGS. 5 to 10, and therefore, an explanation thereof is omitted.

The motion estimation unit 115 obtains the second motion vector of the second frame by performing motion estimation in a predetermined motion search area at the initial point represented by the predicted motion vector S20. For example, the second motion vector can be decided by calculating costs of the motion vectors in the motion search area and obtaining the motion vector having the minimum cost. The costs can be calculated using Equation (9).

Then, the video encoder 100 encodes the second frame using the obtained second motion vector S30. The process of encoding the second frame includes a process in which the motion compensation unit 112 generates the motion compensated frame for the second frame by using the obtained second motion vector and the reference frame of the second frame, a process in which the subtracter 118 obtains the difference between the second frame and the motion compensated frame, a process in which the transform unit 120 generates the transform coefficient by performing a spatial transform on the difference, and a process in which the quantization unit 130 quantizes the transform coefficient.

In addition to the decoding of the frame, i.e., the texture data of the frame, according to the present invention, a process of decoding the motion vector using the similarity between the temporal levels is performed. When the motion vectors of the high frequency frames positioned at the respective temporal levels are obtained through the motion estimation process, the obtained motion vectors are encoded as follows.

First, the motion vector encoding unit 150 obtains the predicted motion vector of the second frame from the motion vectors of the third frame that exists at the upper temporal level S40. Here, the upper temporal level means a temporal level that is one step higher than the present temporal level. The process of obtaining the predicted motion vector has been explained with reference to FIGS. 13 and 14, and therefore, the explanation thereof has been omitted. In addition, the motion vector encoding unit 150 obtains the difference between the second motion vector and the predicted motion vector S50.

If the encoded frame data and the motion vector difference are generated, the entropy encoding unit 140 performs a lossless encoding of them, and finally generates the bitstream S60.

In the process of encoding the motion vector as described above, the motion vector encoding method using the similarity between the temporal levels is not exclusively used, but the motion vector encoding method and the related art encoding method using the spatial similarity, as illustrated in FIG. 2, are adaptively used.

In this case, the motion vector encoding unit 150 obtains the predicted motion vector of the second frame that exists at the present temporal level from the motion vector of the third frame, and obtains the difference (i.e., the first difference) between the motion vector of the second frame and the predicted motion vector. Then, the motion vector encoding unit 150 obtains the predicted motion vector of the second frame using the neighboring motion vectors in the second frame, and obtains the difference (i.e., the second difference) between the motion vector of the second frame and the predicted motion vector obtained using the neighboring motion vectors. Thereafter, the motion vector encoding unit 150 selects the difference that has a smaller number of bits, and inserts the difference into the bitstream as a one-bit flag.

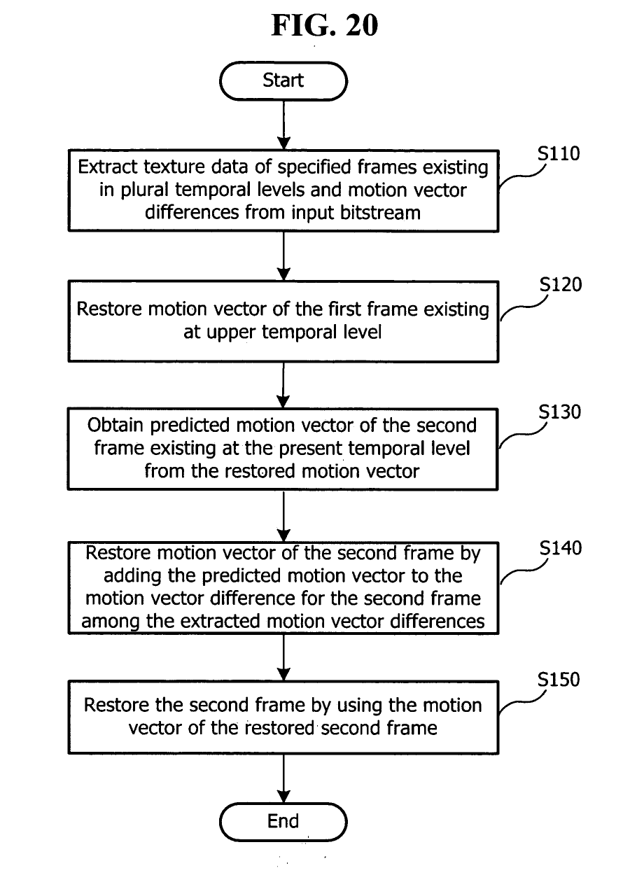

FIG. 20 is a flowchart illustrating a video decoding method according to an exemplary embodiment of the present invention.

First, the entropy decoding unit 210 extracts the texture data of the high frequency frames that exist at plural temporal levels and the motion vector differences from the input bitstream S110.

Then, the motion vector restoration unit 220 restores the motion vector of the first high-frequency frame existing at the upper temporal level S120. If the first high-frequency frame exists at the uppermost temporal level, the motion vector of the first high-frequency frame can be restored irrespective of the motion vectors of other temporal levels.

Also, the motion vector restoration unit 220 obtains the predicted motion vector of the second frame existing at the present temporal level from the restored motion vector S130. This restoration process can be performed by the same algorithm as that used in the motion vector encoding process of the video encoding process of FIG. 19.

Then, the motion vector restoration unit 220 restores the motion vector of the second frame by adding the predicted motion vector to the motion vector difference for the second frame among the extracted motion vector differences S140.

Finally, the video decoder 200 restores the second frame by using the motion vector of the restored second frame S150. The process of decoding the second frame includes a process in which the inverse quantization unit 250 performs inverse quantization on the extracted texture data, a process in which the inverse transform unit 260 performs an inverse transform on the results of inverse quantization, a process in which the motion compensation unit 240 generates the motion compensated frame using the motion vector of the restored second frame and the reference frame at the present temporal level, and a process in which the adder 270 adds the result of the inverse transform to the motion compensated frame.

In the embodiments of the present invention, the process of encoding/decoding the frame (i.e., the second frame) of a certain temporal level (i.e., the present temporal level) and the motion vector (i.e., the second motion vector) has been explained with reference to FIGS. 19 and 20. However, it will be understood by those skilled in the art that the same process can be performed with respect to the frames at another temporal level.

As described above, according to the present invention, the compression efficiency can be improved by efficiently predicting the motion vectors arranged by temporal levels by using the similarity between the temporal levels.

In particular, according to the present invention, efficient motion estimation and motion vector encoding can be implemented in an MCTF-based video codec through the above-described prediction method.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A video encoding method that includes a hierarchical temporal level decomposition process, the video encoding method comprising:
(a) obtaining a predicted motion vector of a second frame, which exists at a present temporal level, from a first motion vector of a first frame that exists at a lower temporal level;
(b) obtaining a second motion vector of the second frame by performing a motion estimation using the predicted motion vector as a start point; and
(c) encoding the second frame using the obtained second motion vector.

2. The video encoding method as claimed in claim 1, wherein the decomposition process is based on motion compensated temporal filtering (MCTF).

3. The video encoding method as claimed in claim 1, wherein (c) comprises:
(c-1) generating a motion compensated frame for the second frame using the obtained second motion vector and a reference frame of the second frame;
(c-2) obtaining a difference between the second frame and the motion compensated frame;
(c-3) generating a transform coefficient by performing a spatial transform on the difference; and
(c-4) quantizing the transform coefficient.

4. The video encoding method as claimed in claim 1, wherein in the case where the first motion vector is a bidirectional motion vector that includes a forward motion vector M(0) and a backward motion vector M(1), and the second motion vector is a forward motion vector, the predicted motion vector M(2)′ is obtained by the equation: M(2)′=M(0)−M(1).

5. The video encoding method as claimed in claim 1, wherein in the case where the first motion vector is a forward motion vector M(0) and the second motion vector is a forward motion vector, the predicted motion vector M(2)′ is obtained by the equation: M(2)′=2×M(0).

6. The video encoding method as claimed in claim 1, wherein in the case where the first motion vector is a backward motion vector M(1) and the second motion vector is a forward motion vector, the predicted motion vector M(2)′ is obtained by the equation: M(2)′=2×M(1).

7. The video encoding method as claimed in claim 1, wherein in the case where the first motion vector is a bidirectional motion vector that includes a forward motion vector M(0) and a backward motion vector M(1), and the second motion vector is a backward motion vector, the predicted motion vector M(2)′ is obtained by the equation: M(2)′=M(1)−M(0).

8. The video encoding method as claimed in claim 1, wherein in the case where the first motion vector is a forward motion vector M(0) and the second motion vector is a backward motion vector, the predicted motion vector M(2)′ is obtained by the equation: M(2)′=−2×M(0).

9. The video encoding method as claimed in claim 1, wherein in the case where the first motion vector is a backward motion vector M(1) and the second motion vector is a backward motion vector, the predicted motion vector M(2)′ is obtained by the equation: M(2)′=2×M(1).

10. The video encoding method as claimed in claim 1, wherein (b) comprises calculating the costs of motion vectors in the motion search area and selecting the motion vector having the minimum cost as the second motion vector.

11. The video encoding method as claimed in claim 10, wherein the cost is defined: C=E+λ×Δ, where E denotes the difference between the second frame and a reference frame for the second frame, Δ denotes the difference between the predicted motion vector and a certain motion vector in the motion search area, and λ denotes a Lagrangian multiplier.

12. A video encoding method that includes a hierarchical temporal level decomposition process, the video encoding method comprising:
(a) obtaining motion vectors of specified frames that exist at a plurality of temporal levels;
(b) encoding the frames using the obtained motion vectors;
(c) obtaining a predicted motion vector of a second frame, which exists at the present temporal level, from a motion vector of a first frame, which exists at the upper temporal level, among the motion vectors;
(d) obtaining the difference between the motion vector of the second frame and the predicted motion vector; and
(e) generating a bitstream that includes the encoded frame and the difference.

13. The video encoding method as claimed in claim 12, wherein the decomposition process is based on motion compensated temporal filtering (MCTF).

14. The video encoding method as claimed in claim 12, wherein (b) comprises:
(b-1) generating a motion compensated frame using the obtained second motion vector and a reference frame of the specified frame;
(b-2) obtaining the difference between the specified frame and the motion compensated frame;
(b-3) generating a transform coefficient by performing a spatial transform on the difference; and
(b-4) quantizing the transform coefficient.

15. The video encoding method as claimed in claim 14, wherein (e) comprises performing a lossless encoding on the result of quantization and the difference.

16. The video encoding method as claimed in claim 13, wherein in the case where the motion vector M(2) of the first frame is a forward motion vector, a predicted motion vector M(0)′ for a forward motion vector M(0) of the second motion vector is obtained by the equation: M(0)′=M(2)/2, and a predicted motion vector M(1)′ for a backward motion vector M(1) of the second motion vector is obtained by the equation: M(1)′=−M(2)+M(0).

17. The video encoding method as claimed in claim 13, wherein in the case where the motion vector M(2) of the first frame is a forward motion vector, and the second motion vector is a backward motion vector M(1), a predicted motion vector M(1)′ for the backward motion vector M(1) is obtained by the equation: M(1)′=−M(2)−M(1).

18. The video encoding method as claimed in claim 13, wherein in the case where the motion vector M(2) of the first frame is a backward motion vector, a predicted motion vector M(0)′ for a forward motion vector M(0) of the second motion vector is obtained by the equation: M(0)′=−M(2)/2, and a predicted motion vector M(1)′ for a backward motion vector M(1) of the second motion vector is obtained by the equation: M(1)′=M(2)+M(0).

19. The video encoding method as claimed in claim 13, wherein in the case where the motion vector M(2) of the first frame is a forward motion vector, and the second motion vector is a backward motion vector M(1), a predicted motion vector M(1)′ for the backward motion vector M(1) is obtained by the equation: M(1)′=M(2)−M(1).

20. The video encoding method as claimed in claim 13, wherein in the case where the motion vector M(2) of the first frame is a forward motion vector, a predicted motion vector M(0)′ for a forward motion vector M(0) of the second motion vector is obtained by the equation: M(0)′=a×M(2)/(a+b), and a predicted motion vector M(1)′ for a backward motion vector M(1) of the second motion vector is obtained by the equation: M(1)′=−M(2)+M(0) wherein a denotes a forward distance rate and b is a backward distance rate.

21. The video encoding method as claimed in claim 13, wherein in the case where the motion vector M(2) of the first frame is a backward motion vector, a predicted motion vector M(0)′ for a forward motion vector M(0) of the second motion vector is obtained by a the equation: M(0)′=−a×M(2)/(a+b), and a predicted motion vector M(1)′ for a backward motion vector M(1) of the second motion vector is obtained by the equation: M(1)′=M(2)+M(0), wherein a denotes a forward distance rate and b is a backward distance rate.

22. A video encoding method that includes a hierarchical temporal level decomposition process, the video encoding method comprising:
(a) obtaining motion vectors of specified frames that exist at a plurality of temporal levels;
(b) encoding the frames using the obtained motion vectors;
(c) obtaining a predicted motion vector of a second frame, which exists at the present temporal level, from a motion vector of a first frame, which exists at the upper temporal level, among the motion vectors, and obtaining the difference between the motion vector of the second frame and the predicted motion vector;
(d) obtaining the predicted motion vector of the second frame using neighboring motion vectors in the second frame, and obtaining the difference between the motion vector of the second frame and the predicted motion vector obtained using the neighboring motion vectors;
(e) selecting the difference that requires a smaller number of bits, between the difference obtained in step (c) and the difference obtained in step (d); and
(f) generating a bitstream that includes the encoded frame and the selected difference.

23. The video encoding method as claimed in claim 22, wherein the bitstream includes a one-bit flag that indicates the result of the selection.

24. The video encoding method as claimed in claim 23, wherein the flag is recorded in the unit of a slice or a macroblock.

25. A video decoding method that includes a hierarchical temporal level restoring process, the video decoding method comprising the steps of:
(a) extracting texture data of specified frames, which exist at a plurality of temporal levels, and motion vector differences from an input bitstream;
(b) restoring a motion vector of a first frame that exists at the upper temporal level;
(c) obtaining a predicted motion vector of a second frame, which exists at the present temporal level, from the restored motion vector;
(d) restoring a motion vector of the second frame by adding the predicted motion vector to the motion vector difference of the second frame among the motion vector differences; and
(e) restoring the second frame using the restored motion vector of the second frame.

26. The video decoding method as claimed in claim 25, wherein the temporal level restoring process follows the frame restoring process of motion compensated temporal filtering (MCTF).

27. The video decoding method as claimed in claim 25, wherein step (e) comprises:
performing an inverse quantization on the texture data;
performing an inverse transform on the result of the inverse quantization;
generating a motion compensated frame using the restored motion vector of the second frame and a reference frame of the present temporal level; and
adding the result of the inverse transform to the motion compensated frame.

28. A video decoding method that includes a hierarchical temporal level restoring process, the method comprising:
(a) extracting a specified flag, texture data of specified frames, which exist at a plurality of temporal levels, and motion vector differences from an input bitstream;
(b) restoring a motion vector of a first frame that exists at the upper temporal level;
(c) restoring neighboring motion vectors in a second frame that exists at the present temporal level;
(d) obtaining a predicted motion vector of the second frame, which exists at the present temporal level, from one of the motion vector of the first frame and the neighboring motion vectors according to the flag value;
(e) restoring a motion vector of the second frame by adding the predicted motion vector to the motion vector difference of the second frame among the motion vector differences; and
(f) restoring the second frame using the restored motion vector of the second frame.

29. A video encoder that includes a hierarchical temporal level decomposition process, the video encoder comprising:
means for obtaining a predicted motion vector of a second frame, which exists at a present temporal level, from a first motion vector of a first frame that exists at a lower temporal level;
means for obtaining a second motion vector of the second frame by performing a motion estimation in a predetermined motion search area using the predicted motion vector as a start point; and
means for encoding the second frame using the obtained second motion vector.

30. A video encoder that performs a hierarchical temporal level decomposition process, the video encoder comprising:
means for obtaining motion vectors of specified frames that exist at a plurality of temporal levels;
means for encoding the frames using the obtained motion vectors;
means for obtaining a predicted motion vector of a second frame, which exists at the present temporal level, from a motion vector of a first frame, which exists at the upper temporal level, among the motion vectors;
means for obtaining a difference between the motion vector of the second frame and the predicted motion vector; and
means for generating a bitstream that includes the encoded frame and the difference.

31. A video decoder that performs a hierarchical temporal level restoring process, the video decoder comprising:
means for extracting texture data of specified frames, which exist at a plurality of temporal levels, and motion vector differences from an input bitstream;
means for restoring a motion vector of a first frame that exists at the upper temporal level;
means for obtaining a predicted motion vector of a second frame, which exists at the present temporal level, from the restored motion vector;
means for restoring a motion vector of the second frame by adding the predicted motion vector to the motion vector difference of the second frame among the motion vector differences; and
means for restoring the second frame by using the restored motion vector of the second frame.
